(19) United States
(12) Patent Application Publication
(10) Pub. No.: US 2025/0052677 A1
(43) Pub. Date: Feb. 13, 2025

(54) EMISSIONS LOCALIZATION AND QUANTIFICATION USING COMBINED UNMANNED AERIAL SYSTEMS AND CONTINUOUS MONITORING

(71) Applicant: SeekOps Inc., Austin, TX (US)

(72) Inventors: Iain Michael Cooper, Canyon Lake, TX (US); Brendan James Smith, Lakeway, TX (US)

(21) Appl. No.: 18/799,823

(22) Filed: Aug. 9, 2024

Related U.S. Application Data
(60) Provisional application No. 63/532,315, filed on Aug. 11, 2023.

(51) Int. Cl. G01N 21/39; G01P 5/02

(52) U.S. Cl. CPC G01N 21/39; G01P 5/02; G01N 2021/399; G01N 2201/068

(57) ABSTRACT

Systems, devices, and methods including a mobile platform comprising: an in situ trace gas sensor, and a device configured to receive an open path laser beam, where the device is at least one of: a retroreflector to receive and return the open path laser beam and a detection device having processing electronics configured to interpret at least one of: a laser dispersion and an absorption signal.

### CROSS-REFERENCE TO RELATED APPLICATIONS

This application claims priority to and the benefit of U.S. Provisional Patent Application No. 63/532,315, filed Aug. 11, 2023, the contents of which are hereby incorporated by reference herein for all purposes.

### TECHNICAL FIELD

Embodiments relate generally to gas emissions measurements, and more particularly to trace gas emissions measurements.

### BACKGROUND

In emissions exploration, gas emission measurements are used to detect emissions of gases of particular interest.

### SUMMARY

A system embodiment may include: a mobile platform comprising: an in situ trace gas sensor; and a device configured to receive an open path laser beam.

In additional system embodiments, the mobile platform may be a drone. In additional system embodiments, the mobile platform further comprises an anemometer configured to generate wind measurements. In additional system embodiments, the device configured to receive the open path laser beam may be a retroreflector subassembly to receive and return the open path laser beam.

Additional system embodiments may include: a fixed laser sensor, where the fixed laser sensor may be configured to emit the open path laser beam and receive the returned open path laser beam from the retroreflector subassembly. Additional system embodiments may include: a mobile laser sensor, where the mobile laser sensor may be configured to emit the open path laser beam and receive the returned open path laser beam from the retro-reflector subassembly.

In additional system embodiments, the device configured to receive the open path laser beam may be a detection device, where the detection device comprises processing electronics configured to interpret at least one of: a laser dispersion and an absorption signal. In additional system embodiments, the in situ trace gas sensor may be an open cavity Tunable Diode Laser Absorption Spectrometer (TDLAS), where the open cavity TDLAS may be configured to refine positional and quantification uncertainty.

Additional system embodiments may include: a processor having addressable memory, where the processor may be in communication with the in situ trace gas sensor, the device configured to receive the open path laser beam, and at least one of: a fixed laser sensor and a mobile laser sensor, where the processor may be configured to: confirm that a gas detected by at least one of: the in situ trace gas sensor, the device configured to receive the open path laser beam, and the at least one of: the fixed laser sensor and the mobile laser sensor may be a trace gas that may be present in a vicinity of the mobile platform rather than somewhere along a path of the open path laser beam.

In additional system embodiments, the processor may be further configured to: determine a position of a localized source emitting the detected gas. In additional system embodiments, the mobile platform may be deployed in response to the gas detected by the at least one of: the fixed laser sensor and the mobile laser sensor to refine the determined position of the localized source and yield a real-time quantification estimate.

Another system embodiment may include: at least one laser sensor each configured to emit an open path laser beam; and at least one mobile platform each including: a first retroreflector configured to reflect the open path laser beam transmitted from the at least one laser sensor, wherein the at least one laser sensor is configured to detect, locate, and quantify trace gas based on the open path laser beam reflected from the first retroreflector.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a range of spatial temporal scales covered by emissions detection and measurement of a system and method, according to one embodiment;

FIG. 1B depicts a diagram of a system for detecting, localizing, and quantifying trace gas using combined unmanned aerial systems and continuous monitoring, according to one embodiment;

FIG. 2 depicts a system and method for wide area emissions sensing using an open path laser sensor, according to one embodiment;

FIG. 3 depicts a system and method for sensing gas emission using a drone-based retroreflector to give enhanced coverage of industrial facilities, according to one embodiment;

FIG. 4 depicts a system and method for sensing gas emission using drone-based retroreflectors in addition to an open cavity Tunable Diode Laser Absorption Spectrometer (TDLAS) measurement to refine positional and quantification uncertainty, according to one embodiment;

FIG. 5A depicts a system with a fixed position laser source and a mobile platform equipped with at least one of a retroreflector, in situ gas sensor, and detecting device, according to one embodiment;

FIG. 5B depicts a system with a mobile laser source and a mobile platform equipped with at least one of a retroreflector, in situ gas sensor, and detecting device, according to one embodiment;

FIG. 6 depicts a flight path of an aerial vehicle having at least one of a retroreflector, in situ gas sensor, and detecting device, relative to a fixed position laser, according to one embodiment;

FIG. 7 depicts a system with a fixed position laser and two or more mobile platforms each equipped with at least one of a retroreflector, in situ gas sensor, and detecting device, according to one embodiment;

FIG. 8 depicts a method of generating a gas flux plane using a laser sensor and a drone-based retroreflector, according to one embodiment;

FIG. 9 depicts a method of generating the gas flux plane of FIG. 8 by a fixed laser sensor and a drone-based retroreflector, according to one embodiment;

FIGS. 10A to 10C depict methods of analyzing trace gas concentration along laser paths traveled by laser beams;

FIG. 11A depicts a system for an aerial vehicle having an in situ gas sensor and a retroreflector, according to one embodiment;

FIG. 11B depicts a system for an aerial vehicle having an in situ gas sensor and a detection device, according to one embodiment;

FIG. 12 depicts a system having a tracking system with a curved retroreflector for two or more laser sensors, according to one embodiment;

FIG. 13 depicts a system having a tracking system with a moveable retroreflector for two or more laser sensors, according to one embodiment;

FIG. 14 depicts a system having a tracking system with a corner retroreflector for two or more laser sensors, according to one embodiment;

FIG. 15 depicts a system having a tracking system with a spherical retroreflector for two or more laser sensors, according to one embodiment;

FIG. 16 illustrates an example top-level functional block diagram of a computing device embodiment;

FIG. 17 shows a high-level block diagram and process of a computing system for implementing an embodiment of the system and process;

FIG. 18 shows a block diagram and process of an exemplary system in which an embodiment may be implemented;

FIG. 19 depicts a cloud computing environment for implementing an embodiment of the system and process disclosed herein; and

FIG. 20 depicts a system for detecting trace gases, according to one embodiment.

### DETAILED DESCRIPTION

The disclosed system and method includes the deployment of a combined in situ trace gas sensor onboard a mobile platform (e.g., in a drone, aerial vehicle, and/or unmanned aerial vehicle (UAV)) that additionally carries a retroreflector subassembly to receive and return an open path laser beam to a fixed or mobile detector.

In some embodiments, instead of carrying a retroreflector, the mobile platform may carry a detection device with processing electronics to interpret the laser dispersion or absorption signal. In other embodiments, the mobile platform may carry both the retroreflector and the detection device.

In some embodiments, an open cavity Tunable Diode Laser Absorption Spectrometer (TDLAS) sensor may be deployed on an unmanned aerial system (UAS) with a high sensitivity enabling the sensor to be flown downwind of any emissions sources, but essentially encompassing the emissions from a site.

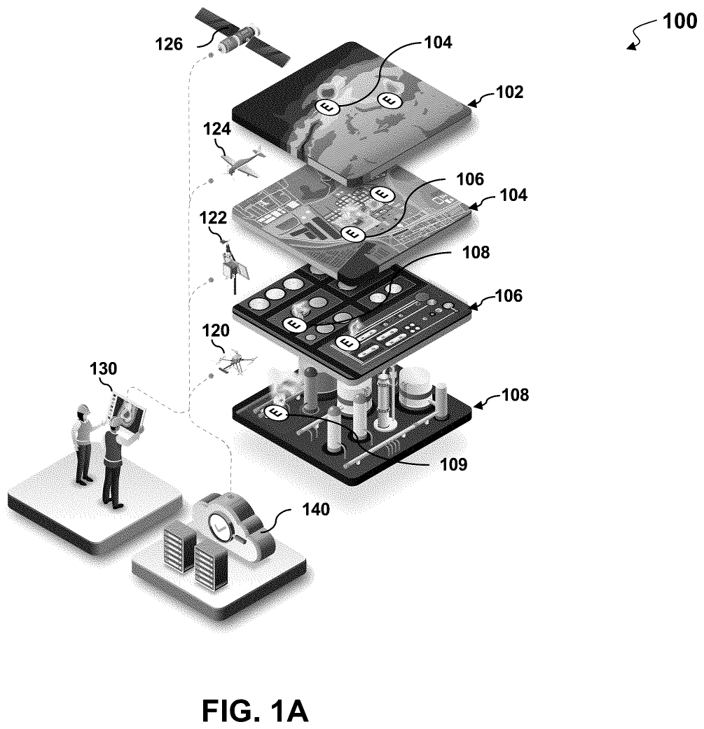

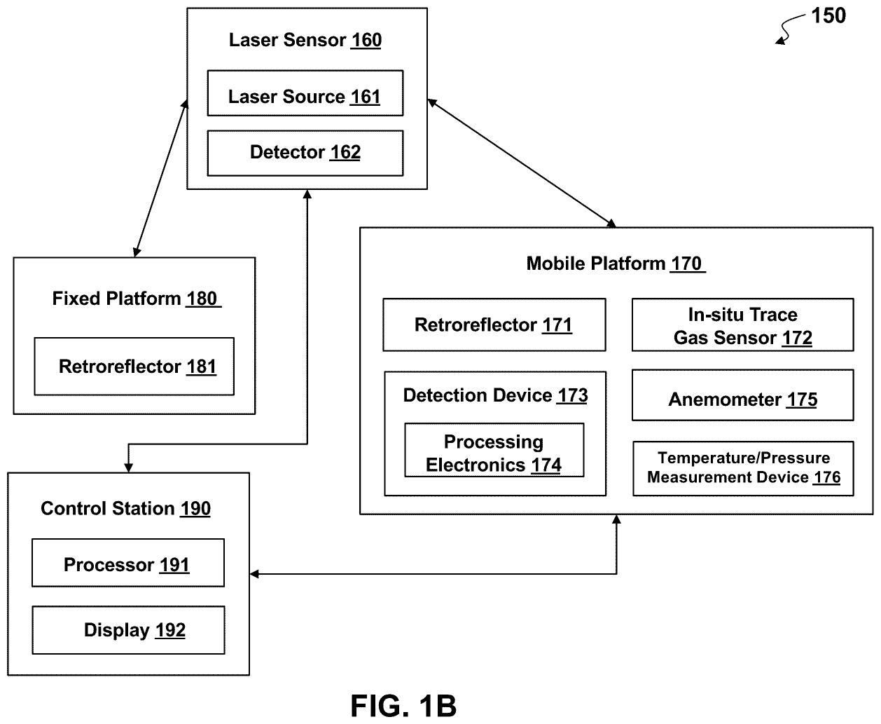

FIG. 1A depicts a range of spatial temporal scales covered by gas emissions detection and measurement system and method 100. The system and method 100 for measurements of gas emissions, particularly those that are considered greenhouse gases, contributing to global warming and/or climate change, such as methane (CH₄) and carbon dioxide (CO₂), may encompass a number of different types and form factors. Key measurements may include: gas concentration in air, temperature, pressure, and/or local wind vector. These measurements may then be converted to an emission rate, so that the leak or fugitive emission can be quantified (e.g., as a mass flowrate).

These measurements may be undertaken on a number of spatial and temporal scales using the components of the system and method 100. In some embodiments, an integrated solution for gas detection, localization, and quantification may include one or more scales. One scale may be early identification of leaks. Leak may be both ‘small’ and ‘large’, realizing that those terms are relative. Another scale may be localization of the leaks, or source attribution. Source attribution may be on a range of length scales (e.g., basin, asset, wellpad, equipment group, component of facility), particularly for remote operations. Another scale may be a frequency of measurement that minimizes lost product (gas) in the most cost-effective manner. Another scale may be quantification of leak rate, whether to calculate how much has been lost or emitted for regulatory and/or voluntary purposes, including the Oil & Gas Methane Partnership (OGMP) 2.0 and carbon credits calculations and accounting. This may also be relevant to auditors or insurance underwriters.

All of these measurements may operate at a range of spatial and temporal scales as shown in FIG. 1A using the system and method 100. These measurements may be used in isolation, e.g., solely an aircraft survey or solely an installation of fixed sensors, and/or in combination as integrated systems.

The disclosed system and method 100 may combines two different laser diagnostics: i) a fixed-position, gimbaled laser dispersion spectroscope with ii) a mobile in situ tunable diode laser absorption spectrometer to yield a step change in detection, localization, and quantification of gas emissions.

Methane flaring, vents, and leaks from industrial operations are one of the major sources of methane, a potent greenhouse gas, with an impact greater than that of vehicles, such as cars, trucks, in the world. The industry may use gas emission estimates based on generic emissions factors (e.g., based on historical performance of equipment). With recent measurements, it is apparent that these emissions factors significantly underestimate the actual emissions, in some cases by approximately 70% or more.

Different systems for measuring gas emissions may be deployed on satellites, manned aircraft, mobile (e.g., ground vehicles, drones, boats, etc.), and fixed sensors, cameras, and continuous monitors. All of these methods may have capabilities and limitations, whether it is a spatial or a temporal issue. For example, drone and aircraft measurements may be discrete and only capture emissions at a particular snapshot of small area in time. Satellites may have large area coverage, but may have a relatively high minimum detection threshold, and may not be able to measure at night or during cloud cover. Fixed cameras and reflectivity based permanent monitors may be somewhat continuous, but many of these devices may suffer from drift and/or require calibration.

The disclosed system and method 100 herein may bridge the temporal gap issue faced by discontinuous measurements of drones by triggering it upon an alarm from the continuous measurement and then accurate refining it with the combined reflectivity and direct measurements. Accordingly, the system 100 may monitor a huge area 102 with a satellite 126. When the satellite 126 detects gas emission in a specific area 104, an airplane 124 may be used to monitor this specific area 104 and may localize a more specific area 106 of gas emission. An onsite laser sensor 122 installed on that area 106 may be used to localize a more specific area 108 where gas emission occurs. Once the specific area 108 with the elevated gas concentration is determined, a mobile platform 120, such as an unmanned aerial vehicle (UAV) equipped with at least one of a retroreflector, gas sensor, and detecting device, may be used to pinpoint the facility 109 and/or location with the gas leak and quantify the trace gas. In some embodiments, the satellite 126 and the onsite laser sensor 122 may be configured to be used for continuous monitoring, and the airplane 124 and the mobile platform 120 may start monitoring by alarms triggered by at least one of the satellites 126 and the onsite laser sensor 122.

A control station 130 may communicate with the satellite 126, the airplane 124, the onsite laser sensor 122, and the mobile platform 120, monitor the status of trace gas concentration in the air and emission events, and control the operations of at least one of the satellites 126, the airplane 124, the onsite laser sensor 122, and the mobile platform 120. A local weather station 140 may provide weather information of at least one of the monitored areas 108, 106, 104, 102 to the control station 130.

FIG. 1B depicts a diagram of a system for detecting, localizing, and quantifying trace gas using a combined unmanned aerial system and continuous monitoring, according to one embodiment. With reference to FIG. 1B, a system 150 may comprise at least one laser sensor 160 and a mobile platform 170. Each of the at least one laser sensor 160 may include a laser source 161 configured to emit an open path laser beam and a detector 162 configured to detect, locate, and quantify trace gas based on the open path laser beam reflected from a first retroreflector 171 mounted on the mobile platform 170. Each of the at least one mobile platform 170 may include the first retroreflector 171 configured to reflect the open path laser beam transmitted from the at least one laser sensor 160. In some embodiments, any one of the at least one laser sensor 160 may be fixed in the monitored area or may be mounted on a mobile platform.

In some embodiments, the system 150 may further comprise at least one second retroreflector 181. Each of the at least one second retroreflector 181 may be located in a fixed platform 180 in the monitored area and configured to monitor the monitored area continuously.

In some embodiments, the system 150 may further comprise a processor 191 having addressable memory, which may be located in a control station 190. The processor 191 may be in communication with the at least one laser sensor 160 and the at least one mobile platform 170. In addition, the processor 191 may be configured to: generate an alarm when the at least one laser sensor 160 detects trace gas based on the open path laser beam reflected from the second retroreflector 181 during the continuous monitoring and transmit the alarm to the at least one mobile platform 170. Once the alarm is received in the mobile platform 170, the operations of the at least one mobile platform 170 may be triggered by the alarm. That is, the at least one mobile platform 170 equipped with the first retroreflector 171 may start flying for more close monitoring. The first retroreflector 171 onboard may reflect the open path laser beam from the laser sensor 160 during the flight of the mobile platform 170, and in some embodiments, an in situ trace gas sensor 172 mounted on the mobile platform 170 may detect, localize, and quantify trace gas independently. In some embodiments, the control station 190 may further include a display 192 through which an operator may monitor status of trace gas concentration in the air and gas emission events and control the operations of the laser sensor 160 and the mobile platforms 170.

In some embodiments, the at least one mobile platform 170 may further include the in situ trace gas sensor 172. The in situ trace gas sensor 172 may be configured to: receive the open path laser beam from the at least one laser sensor 160, independently detect, locate, and quantify trace gas, and refine positional and quantification uncertainty obtained by the at least one laser sensor 160. The operations of the in situ trace gas sensor 172 may be triggered by the alarm from the control station 190, which has been generated based on the trace gas detection of the laser sensor 160. Since the in situ trace gas sensor 172 may detect, localize, and quantify trace gas during the flight of the mobile platform 170 in addition to the laser sensor 160, it is possible to perform more close and accurate monitoring near the gas leak and thus refine the positional location of the leak source and real-time quantification estimate obtained from the laser sensor 160, while maintaining monitoring efficiency.

In some embodiments, the at least one mobile platform 170 may be a plurality of mobile platforms 170, and a plurality of first retroreflectors 171 of the plurality of mobile platforms 170 may be configured to reflect the open path laser beams transmitted from the single laser sensor 160. In some embodiments, the at least one laser sensor 160 may include a plurality of laser sensors, and the plurality of laser sensors 160 may be configured to aim to a single first retroreflector 171 of the mobile platform 170. In this case, the first retroreflector 171 may be at least one of: a curved retroreflector, a moveable planar retroreflector, a corner retroreflector, and a spherical retroreflector.

In some embodiments, the mobile platform 170 may further include a detection device 173, and the detection device 173 may comprises processing electronics 174 configured to interpret at least one of: a laser dispersion and an absorption signal of the open path laser beams transmitted from the single laser sensor 160.

In some embodiments, the mobile platform 170 may further includes at least one of an anemometer 175, a temperature measurement device 176, and a pressure measurement device 176. The wind, pressure, or temperature measurements obtained by the anemometer 175, temperature measurement device 176, and pressure measurement device 176 may be used for more accurate gas emission monitoring.

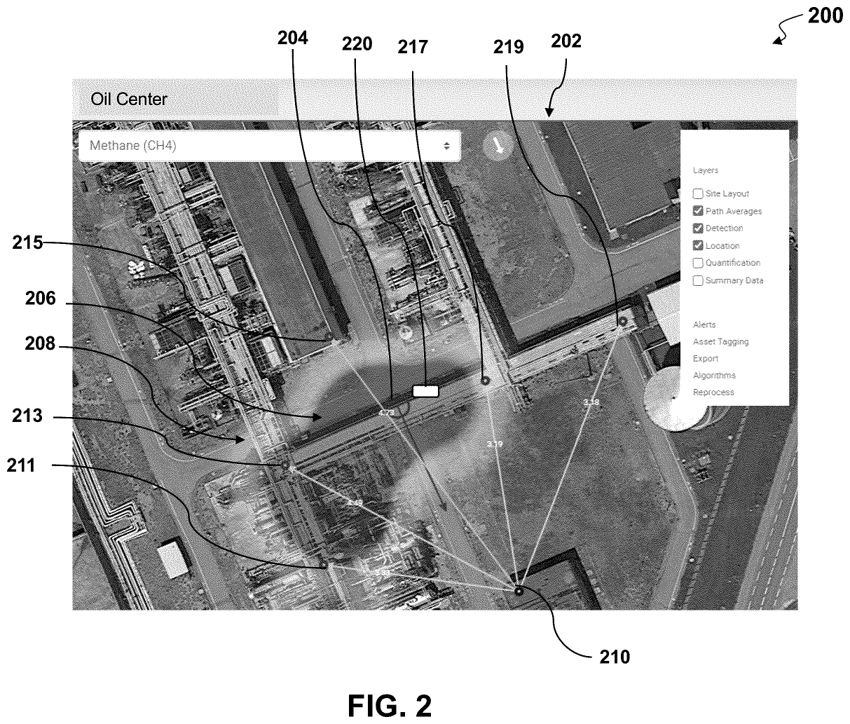

FIG. 2 depicts a system and method 200 for wide area emissions sensing. With reference to FIG. 2, the system 200 may comprise an open path laser sensor 210, a plurality of retroreflectors 211, 213, 215, 217, 219, and a mobile platform 220 equipped with a retroreflector and/or an in situ trace gas sensor. The open path laser sensor 210 and the plurality of retroreflectors 211, 213, 215, 217, 219 may be configured to perform continuous monitoring of a wide area 202 where a plurality of industrial facilities, such as oil centers, are located. The mobile platform 220 may be equipped with a retroreflector and/or an in situ trace gas sensor onboard, and upon an alarm from the continuous monitoring, the mobile platform 220 may start moving around the facilities, and the retroreflector and/or in situ trace gas sensor onboard may be configured to perform close monitoring of a specific area while the mobile platform 220 moves around. In some embodiments, the mobile platform 220 may be an unmanned aerial vehicle (UAV), such as drone, but is not limited thereto.

The open path laser sensor 210 may be mounted on the roof or a high point of the facilities. The open path laser sensor 210 may be configured to transmit the open path laser beam and detect, localize, and quantify gas emission using the received laser beam returned from any of the multiple retroreflectors 211, 213, 215, 217, 219. The laser beam from the laser sensor 210 may be configured to detect a number of chemical species, including methane (CH₄), carbon dioxide (CO²), and others. In some embodiments, the laser sensor 210 may be a laser dispersion spectroscopy methane sensor, which may be a highly sensitive device (10 ppb, with high noise resistance). In some embodiments, this laser sensor 210 may deploy an open path laser across a large area. In this case, the single laser sensor may cover at least approximately 1 km² (FIG. 2). An emissions report may then be generated based on modelled gas plumes.

This system and method 200 may be performed based on the positioning of the multiple retroreflectors 211, 213, 215, 217, 219. The multiple retroreflectors 211, 213, 215, 217, 219 may be permanently placed and fixed around the industrial facilities and configured to reflect the laser beam from the open path laser sensor 210 with a 360 degree view. This process may be used even in rain, fog, and snow. The effective emission rates measured may be less than approximately 1 kg/hr, which may be similar to an open cavity Tunable Diode Laser Absorption Spectrometer (TDLAS) sensor, with the wind data based on the use of local weather station information.

In some embodiments, the mobile platform 220 equipped with the retroreflector and/or in situ gas sensor may be triggered by an alarm from the system 200, to again both refine the positional location of the leak source, but also yield a real-time quantification estimate. Specifically, the open path laser sensor 210 and the plurality of retroreflectors 211, 213, 215, 217, 219 may provide continuous gas emission monitoring of the wide area 202 using the large area coverage and weather data. When the system 200 initially detects trace gas emission, locate the leak source, and quantify trace gas based on the continuous monitoring using the open path laser sensor 210 and the plurality of retroreflectors 211, 213, 215, 217, 219, the system 200 may generate an alarm for triggering the operations of the mobile platform 220 equipped with the retroreflector and/or in situ gas sensor.

In some embodiments, the alarm may include information regarding a specific area where the gas concentration is measured high. For example, in a case where gas leak occurs at a certain facility 204, gas concentration may be high in a first zone 206 covering the facility 204 and become lower in a second zone 208 surrounding the first zone 206 as it goes away from the facility 204. Among the first to fifth retroreflectors 211, 213, 215, 217, 219, the second retroreflector 213 and third retroreflector 215 located in positions where the paths of the laser beam pass through the first zone 206 may detect high gas concentrations (e.g. 4.49 and 4.73), respectively, while the first retroreflector 211 and the fourth retroreflector 217 in positions where the paths of the laser beam pass through only the second zone 208, not the first zone 206, may detect relatively low gas concentrations (e.g. 3.83 and 3.19), respectively. The fifth retroreflector 219 located in a position where the path of the laser beam is far from the affected area may detect low gas concentration (e.g. 3.18). Based on these concentrations of the spatially distributed multiple retroreflectors 211, 213, 215, 217, 219, the system 200 may determine the specific area that needs close monitoring and include this information in the alarm for the close monitoring of the mobile platform 220.

As mentioned above, the operations of the mobile platform 220 equipped with the retroreflector and/or in situ gas sensor may be triggered by the alarm transmitted from the system 200. Once the mobile platform 220 receives the alarm from the system 200, the mobile platform 220 equipped with the retroreflector and/or in situ gas sensor may fly around the facilities or area having the elevated gas concentration, such as the first zone 208, and the retroreflector and/or the in situ gas sensor onboard may be used to perform close monitoring of gas emission, including localization of an emission source and quantification of gas emission to refine positional and quantification uncertainty.

In some embodiments, the mobile platform 220 may be an unmanned aerial vehicle (UAV), such as drone, but is not limited thereto. The retroreflector mounted on the UAV 220 may reflect the laser beam transmitted from the open path laser sensor 210 from various positions while the UAV flies around the facilities in the specific area reported as high gas concentration area based on the initial continuous monitoring. The mobility of the UAV 220 may allow the onboard retroreflector to reflect the laser beam from the various positions and thus enable the detailed monitoring, localization, and quantification of gas emission. In some embodiments, in addition to the retroreflector, the in situ gas sensor mounted on the UAV 220 may independently detect, localize, and quantify trace gas while the UAV 220 flies around the facilities in the specific area reported as a high gas concentration area based on the initial continuous monitoring. Thus, the data generated by the in situ gas sensor may provide additional information on the localized source and improve quantification by increasing the accuracy and lowering the false alarm rate.

The system and method 200 may be more effective for facilities distributed in a horizontal layout than offshore platforms where facilities are stacked in vertical multi-deck layout, partially due to the complexity of multi-deck layouts on offshore platforms. However, the system and method 200 may not be limited to monitoring facilities distributed in a horizontal layout. The system and method 200 may also be used for monitoring facilities distributed in a vertical layout, such as multi-deck structure, or in a combination of horizontal and vertical layouts.

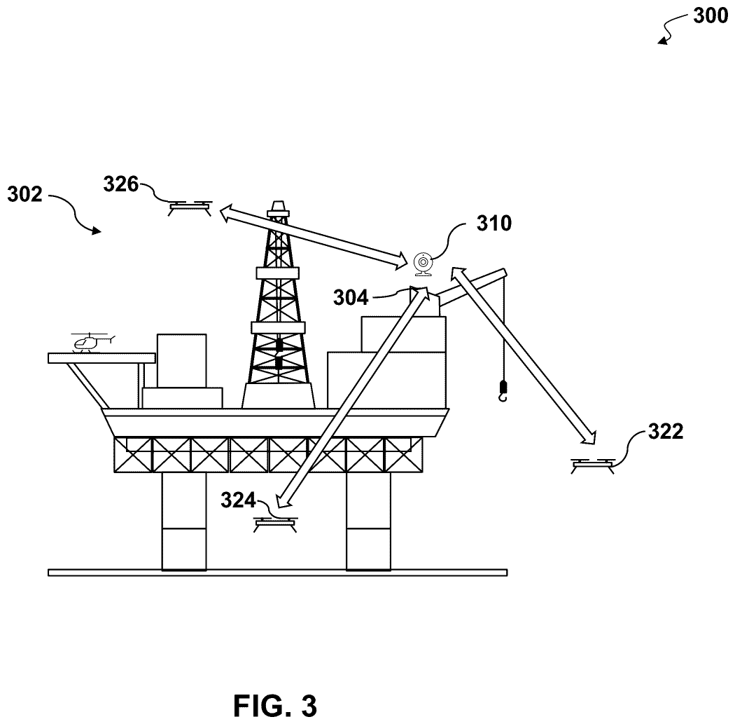

FIG. 3 depicts a system and method 300 for sensing gas emission using a retroreflector mounted on a mobile platform for enhanced coverage of gas emission. With reference to FIG. 3, the system and method 300 may comprise an open path laser sensor 310 and one or more mobile platforms 322, 324, 326 each equipped with a retroreflector. The industrial facilities in a monitored area 302 may be in various layouts, including at least one of vertical multi-deck layout, horizontal layout, and a combination thereof. In some embodiments, the industrial facilities in the monitored area 302 may be offshore facilities where oil and gas operations are performed. The open path laser sensor 310 may be mounted on any point 304 of the industrial facilities in the monitored area 302. For example, the open path laser sensor 310 may be mounted on a roof or a high point 304 but is not limited thereto. Meanwhile, the retroreflectors may be mounted on any type of mobile platform. The retroreflectors may be mounted on unmanned aerial vehicles (UAVs) 322, 324, 326 such as drones but are not limited thereto.

The open path laser sensor 310 may be configured to transmit laser beam and detect, localize, and quantify gas emission using the received laser beam returned from the retroreflectors on the UAVs 322, 324, 326. In some embodiments, the open path laser sensor 310 may be a laser dispersion spectroscopy methane sensor but is not limited thereto. Each of the UAVs 322, 324, 326 with the retroreflectors may be configured to fly around the industrial facilities, and each of the retroreflectors on the UAVs 322, 324, 326 may reflect the laser beams transmitted from the open path laser sensor 310. The open path laser sensor 310 may be provided expanded coverage by flying the UAVs 322, 324, 326 with the retroreflectors to gain access to a broader area in and around platforms or in and around more complex industrial facilities. The retroreflectors on the UAVs 322, 324, 326 may be configured to reflect the laser beams from any positions during the flight. This may clearly give the potential to cover areas where it would not be feasible to put the fixed retroreflectors and can also enable more precise localization in areas that may have been blocked from the original path of the laser beam. In some embodiments, more than one retroreflector equipped UAVs may be deployed, given the 360 degree coverage of the device for enhanced coverage.

In some embodiments, the system and method 300 may further comprise multiple fixed retroreflectors, and the operations of the UAVs 322, 324, 326 equipped with retroreflectors may be triggered by an alarm generated based on the initial continuous monitoring using the multiple fixed retroreflectors as described in FIG. 2. The alarm may include information regarding a specific area where the gas concentration is measured high, and the UAVs 322, 324, 326 equipped with retroreflectors may be configured to move around the specific area for close monitoring. The mobility of the UAVs 322, 324, 326 may allow the onboard retroreflectors to reflect the laser beam of the open path laser sensor 310 from the various positions and thus enable the detailed monitoring, localization, and quantification of gas emission.

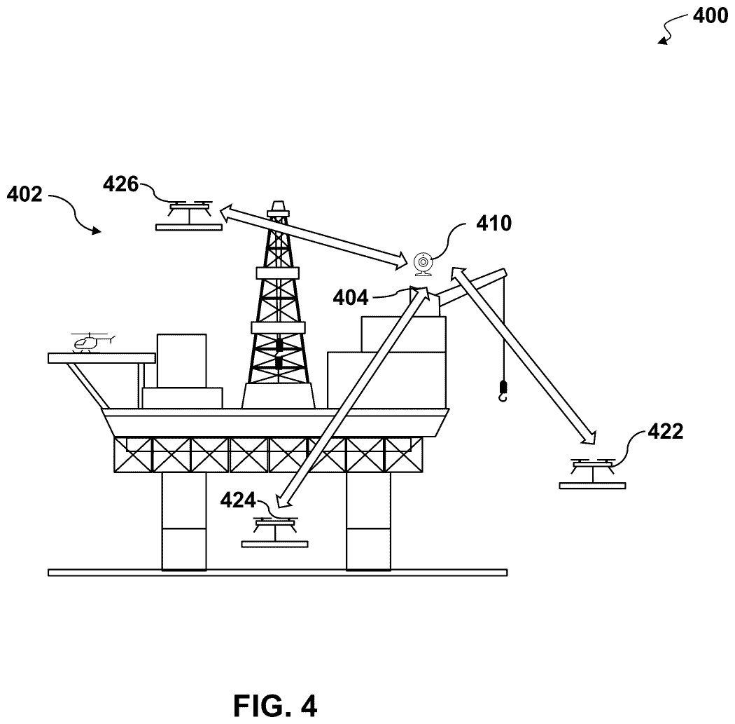

FIG. 4 depicts a system and method 400 for sensing gas emission using a retroreflector and an in situ gas sensor both mounted on a mobile platform for enhanced coverage and refining positional and quantification uncertainty of gas emission. With reference to FIG. 4, the system and method 400 may comprise an open path laser sensor 410 and one or more mobile platforms 422, 424, 426 each equipped with both a retroreflector and an in situ gas sensor. The industrial facilities in a monitored area 402 may be arranged in various layouts, including at least one of vertical multi-deck layout, horizontal layout, and a combination thereof. In some embodiments, the industrial facilities in the monitored area 402 may be offshore facilities where oil and gas operations are performed. The open path laser sensor 410 may be mounted on any point 404 of the industrial facilities in the monitored area 402. For example, the open path laser sensor 410 may be mounted on a roof or a high point 304 but is not limited thereto. Meanwhile, the retroreflectors and in situ gas sensor may be mounted on any type of mobile platform. The retroreflectors and in situ gas sensor may be mounted on unmanned aerial vehicles (UAVs) 422, 424, 426 such as drones but are not limited thereto.

The open path laser sensor 410 may be configured to transmit laser beam and detect, localize, and quantify trace gas using the received laser beam returned from the retroreflectors mounted on the UAVs 422, 424, 426. Each of the UAVs 422, 424, 426 with the retroreflectors may be configured to fly around the industrial facilities, and the retroreflectors on the UAVs 422, 424, 426 may reflect the laser beams transmitted from the open path laser sensor 410. The open path laser sensor 410 may be provided expanded coverage by flying the UAVs 422, 424, 426 with the retroreflectors to gain access to a broader area. The retroreflectors on the UAVs 422, 424, 426 may be configured to reflect the laser beams from any positions during the flight.

In addition to the retroreflectors, each of the UAVs 422, 424, 426 may also include an in situ gas sensor. Whilst the retroreflectors on the UAVs 422, 424, 426 get around certain limitations of the open path laser and fixed retroreflector approach, the uncertainty of the reflection-based concentration measurement may be refined by adding one or more in situ gas sensors to the one or more UAVs 422, 424, 426 that also have retroreflectors placed thereon. Since the in situ gas sensors on the UAVs 422, 424, 426 are configured to independently detect and measure gas concentrations during the flight, the in situ gas sensors may give additional information on the localized source and improve quantification by increasing the accuracy and lowering the false alarm rate.

In some embodiments, the open path laser sensor 410 may be a laser dispersion spectroscopy methane sensor but is not limited thereto. In some embodiments, any of the in situ gas sensors on the UAVs 422, 424, 426 may be an open cavity Tunable Diode Laser Absorption Spectrometer (TDLAS) sensor but is not limited thereto. In some embodiments, the retroreflectors and in situ gas sensors may be mounted on drones but are not limited thereto. The retroreflectors and in situ gas sensors may be mounted on any type of mobile platform.

In some embodiments, the one or more UAVs 422, 424, 426 may also include an anemometer deployed to measure a wind vector. The anemometer would provide a more detailed coverage of the wind as compared to other wind measurements or wind data.

In some embodiments, the system and method 400 may further comprise multiple fixed retroreflectors, and the operations of the UAVs 422, 424, 426 equipped with retroreflectors and in situ gas sensor may be triggered by an alarm generated based on the initial continuous monitoring using the multiple fixed retroreflectors as described in FIG. 2. The alarm may include information regarding a specific area where the gas concentration is measured high, and the UAVs 422, 424, 426 equipped with the retroreflectors and in situ gas sensors may be configured to move around the specific area for close monitoring. The mobility of the UAVs 422, 424, 426 may allow the onboard retroreflectors to reflect the laser beam of the open path laser sensor 410 from the various positions and thus enable the detailed monitoring, localization, and quantification of gas emission. In addition, the in situ gas sensor mounted on the UAVs 422, 424, 426 may independently detect gas emission while the UAVs 422, 424, 426 fly around the facilities in the specific area reported as a high gas concentration area based on the initial continuous monitoring. Thus, the data generated by the in situ gas sensor on the UAVs 422, 424, 426 may provide additional information on the localized source and improve quantification by increasing the accuracy and lowering the false alarm rate.

The systems disclosed herein may have a fourfold impact in improving the quality of gas monitoring results. First, this approach enables more precise spatial coverage (detection capabilities) between the permanently fixed retroreflectors and the permanently fixed laser source. Second, this approach confirms that the detected gas is indeed methane and is physically present in the vicinity of the mobile platform, rather than somewhere along the reflection path of the laser beam, thus refining the initial positional source localization. Third, with the wind data, this approach enables a refined calculation of the position of the localized source, particularly if the leak source is hidden behind equipment and not visible with direct line of site. Fourth, this approach enables improved quantification by combining the open path laser spectroscope algorithms using the open path and retroreflectors and the quantification algorithms used in the open cavity analysis.

While offshore facilities for oil and gas operations are depicted in FIGS. 3 and 4, the systems of the present disclosure are not limited to offshore facilities and may be deployed on onshore industrial facilities in a number of industries. In some embodiments, the system of the present disclosure may be used to monitor sites with renewable natural gas and biogas and/or biomethane production facilities.

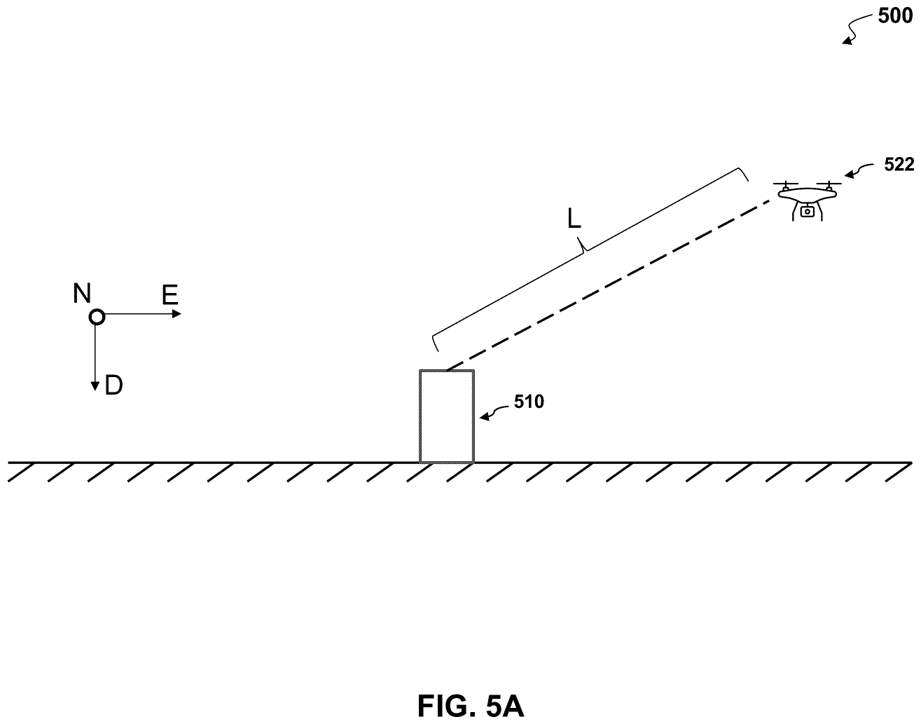

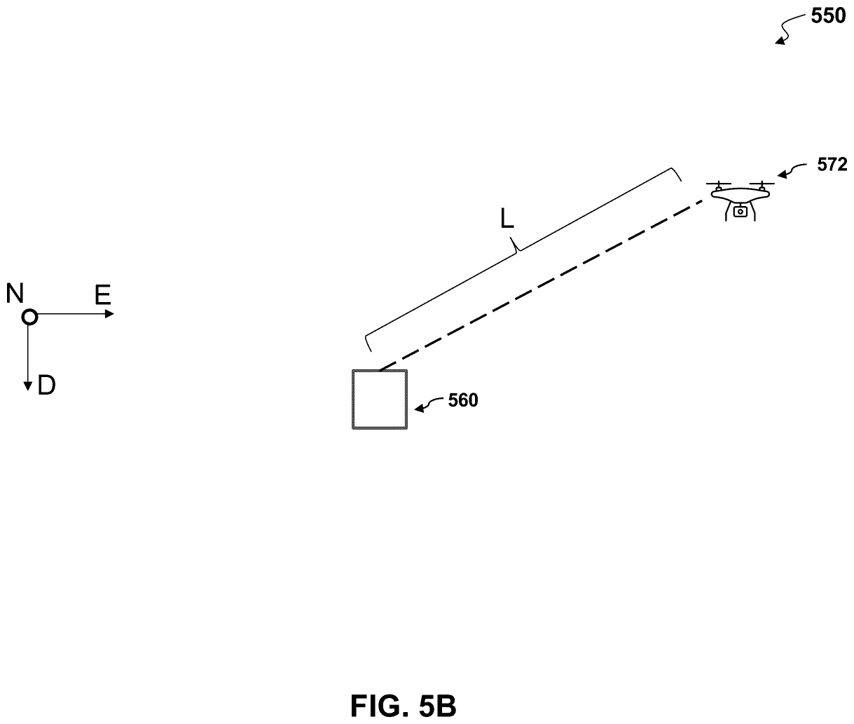

FIG. 5A depicts a system 500 with a fixed position laser source 510 and mobile platform 522 equipped with at least one of a retroreflector, in situ gas sensor, and detecting device. The mobile platform 522 may be positioned at a distance L away from the laser sensor 510 while it moves around the monitored area. The fixed position laser source 510 may be fixed on the ground or at a certain point of facilities in a monitored area and configured to emit an open path laser beam. In some embodiments, the mobile platform 522 may be equipped with the in situ gas sensor configured to detect, localize, and quantify trace gas based on the transmitted laser beam from the fixed position laser source 510. In some embodiments, the fixed position laser source 510 may include a detector configured to detect, locate, and quantify trace gas based on the open path laser beam reflected from the retroreflector on the mobile platform 522.

FIG. 5B depicts a system 550 with a mobile laser source 560 and a mobile platform 572 equipped with at least one of a retroreflector, in situ gas sensor, and detecting device. The mobile platform 572 may be positioned at a distance L from the mobile laser sensor 560. The mobile laser sensor 560 may be a laser sensor mounted on a mobile platform, and the mobile platform 572 equipped with a retroreflector, in situ gas sensor, and/or detecting device may be another mobile platform, such as a UAV. In some embodiments, the fixed position laser source 560 may include a detector configured to detect, locate, and quantify trace gas based on the open path laser beam reflected from the retroreflector on the mobile platform 572.

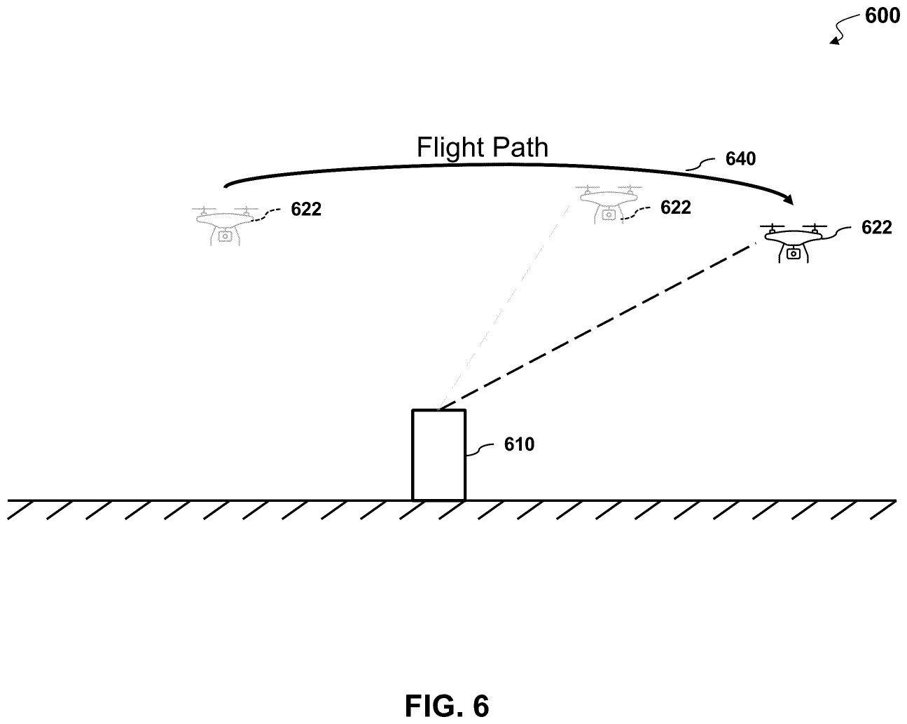

FIG. 6 depicts a system 600 with a mobile platform 622 equipped with at least one of a retroreflector, in situ gas sensor, and detecting device relative to a fixed position laser source 610. Referring to FIG. 6, the mobile platform 622 may fly along a flight path 640 at a distance away from a fixed position laser source 610. In some embodiments, the mobile platform 622 may be a UAV, such as a drone, but is not limited thereto. The mobile platform 622 may fly within a line of sight (LOS) of the fixed position laser source 610 to measure trace gas concentrations at various locations in a wider combination as compared to a fixed retroreflector.

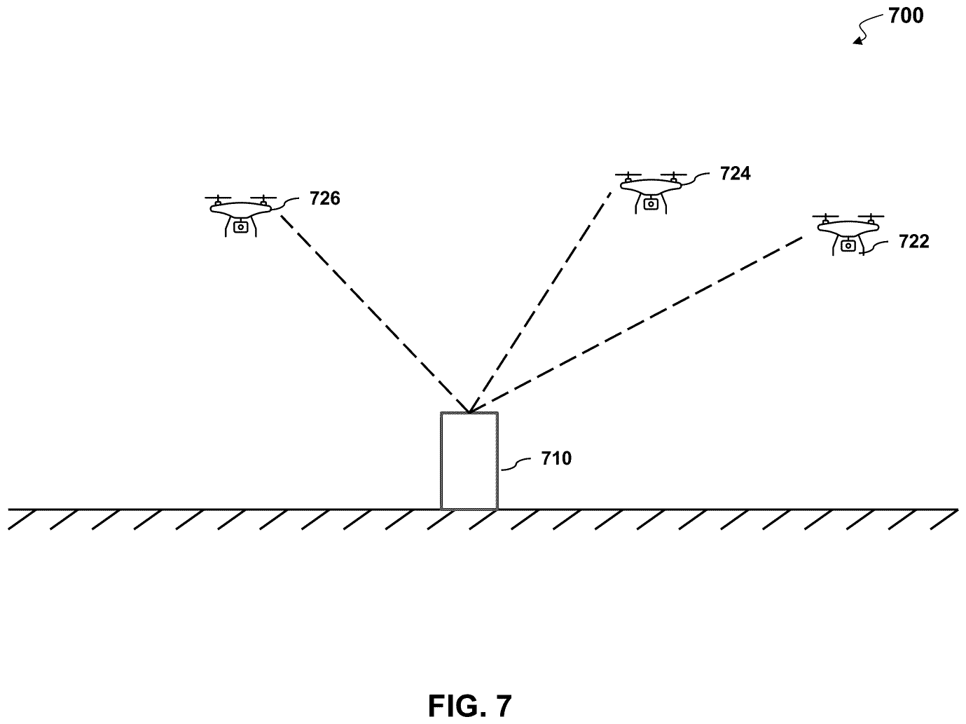

FIG. 7 depicts a system 700 with a fixed position laser source 710 and two or more mobile platforms 722, 724, 726 each equipped with at least one of a retroreflector, in situ gas sensor, and detecting device. In some embodiments, each of the mobile platforms 722, 724, 726 may include a retroreflector, a detection device, and/or an anemometer. In some embodiments, the fixed position laser source 710 may include a detector configured to detect, locate, and quantify trace gas based on the open path laser beam reflected from the retroreflectors on the mobile platform 722, 724, 726. In some embodiments, the mobile platforms 722, 724, 726 may be UAVs, such as drones, but are not limited thereto.

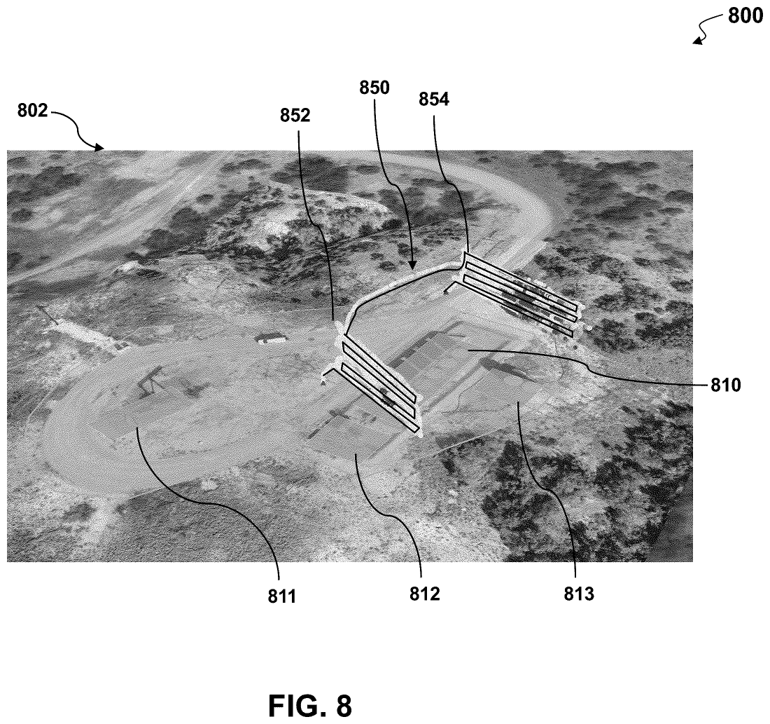

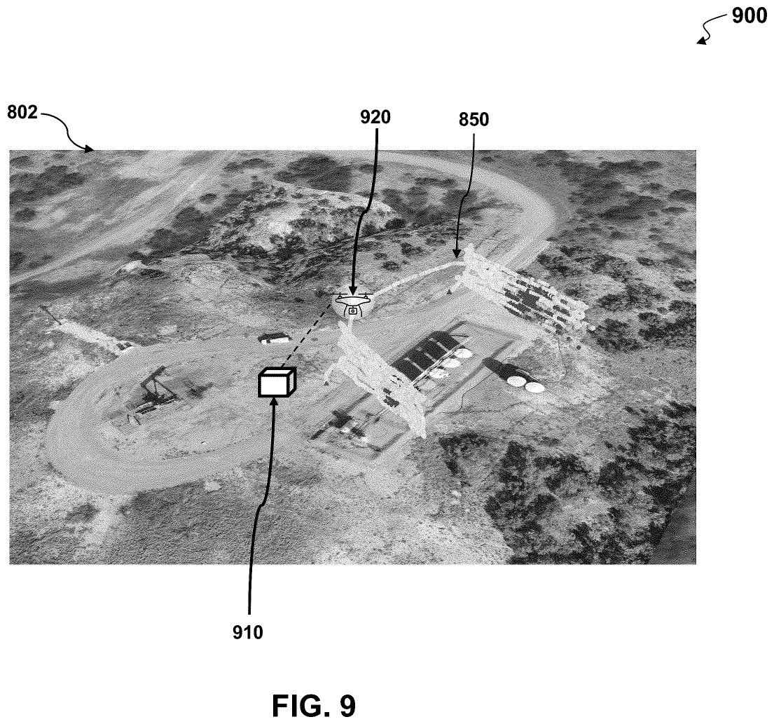

FIG. 8 depicts a system and method 800 of generating a gas flux plane near a certain facility by using a laser source and a mobile platform equipped with at least one of a retroreflector, in situ gas sensor, and detecting device. FIG. 9 depicts a system and method 900 of generating the gas flux plane of FIG. 8 by a fixed laser source 910 and a mobile detector 920 on an aerial vehicle. With reference to FIGS. 8 and 9, a monitored site 802 may include a plurality of facilities 810, 811, 812, 813, and any of these facilities may be more closely monitored using the laser source 910 and a mobile platform 920 equipped with the retroreflector and/or in situ gas sensor. In some embodiments, the laser source 910 may be installed on the monitored area, and the in situ trace gas sensor on the mobile platform 920 may be configured to monitor gas leak of the facility 810 using the laser beam passing through the air near the facility 810 from the laser source 910. In some embodiments, the laser source 910 may include a detector configured to detect trace gas based on the laser beam reflected from the retroreflector on the mobile platform 920. The system 900 may determine the mobile platform 920's flight path 850, which covers at least one plane near the facility 810. The at least one plane may be a gas flux plane, which is the volume of gas crossing the plane per unit time. In some embodiments, the flight path 850 of the mobile platform 920 may cover two vertical planes 852, 854 on both sides of the facility 810. The in situ gas sensor on the mobile platform 920 may sense the concentrations of gas at a plurality of points of the flight path 850 while the mobile platform 920 flies through the flight path. The detected gas concentrations along the flight path 850 may form gas flux planes 842, 844.

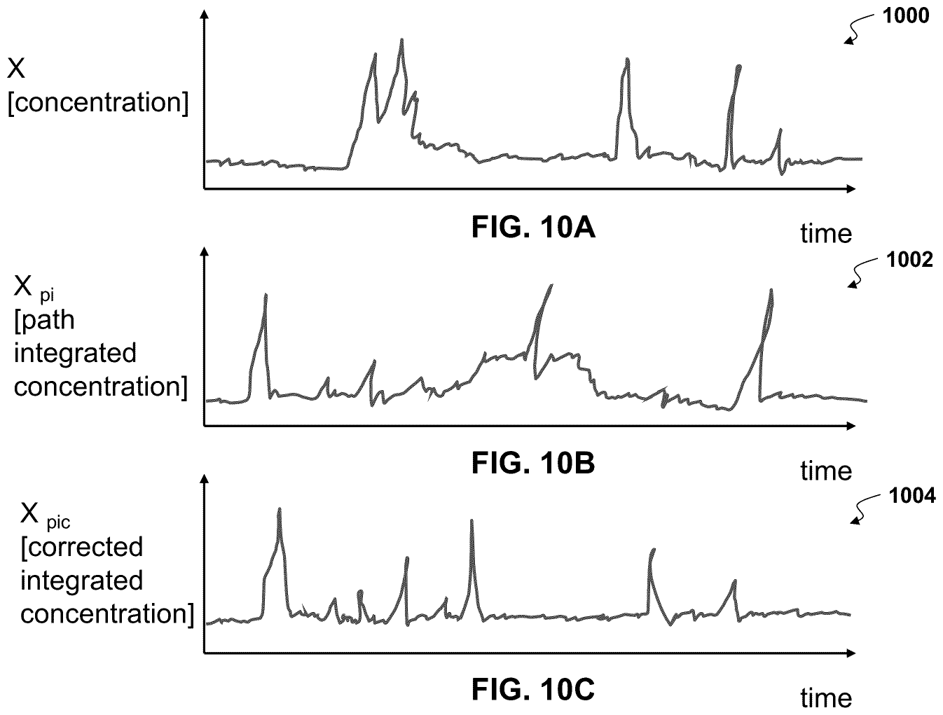

FIGS. 10A to 10C depict methods of analyzing trace gas concentration along laser paths traveled by laser beams 1000, 1002, 1004. The laser beams 1000, 1002, 1004 may be travelled from a laser source to a retroreflector and then reflected at the retroreflector to a detector. The laser source and the detector may be included in a single laser sensor as components. The retroreflector may be mounted on a drone and detect the laser beams 1000, 1002, 1004 while flying along a flight path. With reference to a graph 1000 in FIG. 10A, X (units of ppm) represents the instantaneous point concentration along the flight path of the drone equipped with the detector in 3D space (x, y, z).

With reference to a graph 1002 in FIG. 10B, X_PI (units of ppm*m) represents the integrated concentration along the entire laser path. The distance d of the entire laser path travelled by the laser beam is twice a distance L between the laser source and the detector (d=2*L) because the laser beam passes from the laser source of the sensor to the retroreflector and back to the detector of the sensor.

With reference to a graph 1004 in FIG. 10C, X_PIC (units of ppm*m) represents the average concentration along the entire laser path travelled by the laser beam. The average concentration along the entire laser path X_PIC may be acquired by dividing the integrated concentration along the entire laser path X_PI by the total distance 2L of entire laser path (X_PIC=X_PI/(2*L)).

In other embodiments, the system and method of analyzing trace gas concentration may further include analyzing density, pressure, or temperature for more accurate gas emission monitoring. In this case, the concentration may be replaced by density, pressure, or temperature. Measurements are for one or more gas species of interest, such as trace gases.

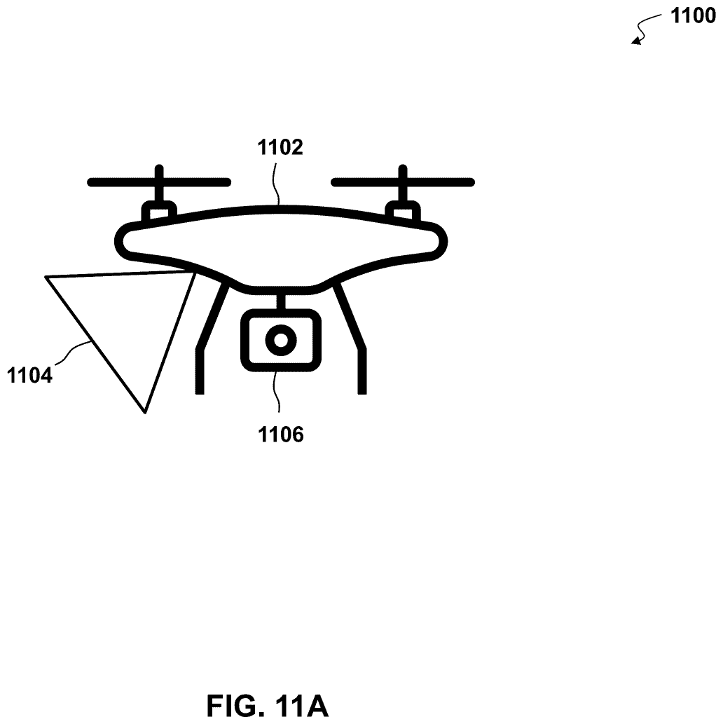

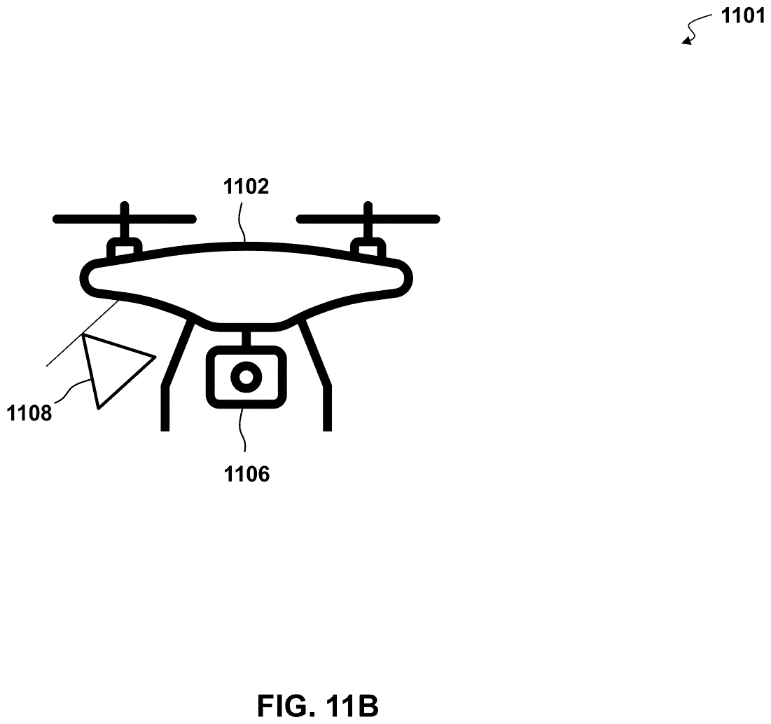

FIGS. 11A and 11B depict systems 1100, 1101 for mobile platforms each equipped with at least one of in situ gas sensor, retroreflector, and detection device. In some embodiments, the mobile platforms of the systems 100 to 900 described in FIGS. 1A to 9 may be any one of mobile platforms described in FIGS. 11A and/or 11B.

FIG. 11A depicts a system 1100 for an aerial vehicle 1102 having an in situ gas sensor 1106 and a retroreflector 1104. The system 1100 may include an aerial vehicle 1102 such as a drone or unmanned aerial vehicle (UAV). The aerial vehicle 1102 may be any variety of shapes of dimensions. The retroreflector 1104 may be any variety of shapes or dimensions. The retroreflector 1104 may be attached to or otherwise connected to the aerial vehicle 1102 and/or the in situ gas sensor 1106. The in situ gas sensor 1106 may be any variety of shapes or dimensions. The in situ gas sensor 1106 may be attached to or otherwise connected to the aerial vehicle 1102 and/or the retroreflector 1104. In some embodiments, an anemometer and/or wind measurement device (not shown) may be attached or otherwise connected to the aerial vehicle 1102 and/or the retroreflector 1104.

FIG. 11B depicts a system 1101 for an aerial vehicle 1102 having an in situ gas sensor 1106 and a detection device 1108. The system 1101 may include an aerial vehicle 1102 such as a drone or unmanned aerial vehicle (UAV). The aerial vehicle 1102 may be any variety of shapes of dimensions. The detection device 1108 may be any variety of shapes or dimensions. The detection device 1108 may be attached to or otherwise connected to the aerial vehicle 1102 and/or the in situ gas sensor 1106. The in situ gas sensor 1106 may be any variety of shapes or dimensions. The in situ gas sensor 1106 may be attached to or otherwise connected to the aerial vehicle 1102 and/or the detection device 1108. In some embodiments, an anemometer and/or wind measurement device (not shown) may be attached or otherwise connected to the aerial vehicle 1102 and/or the detection device 1108.

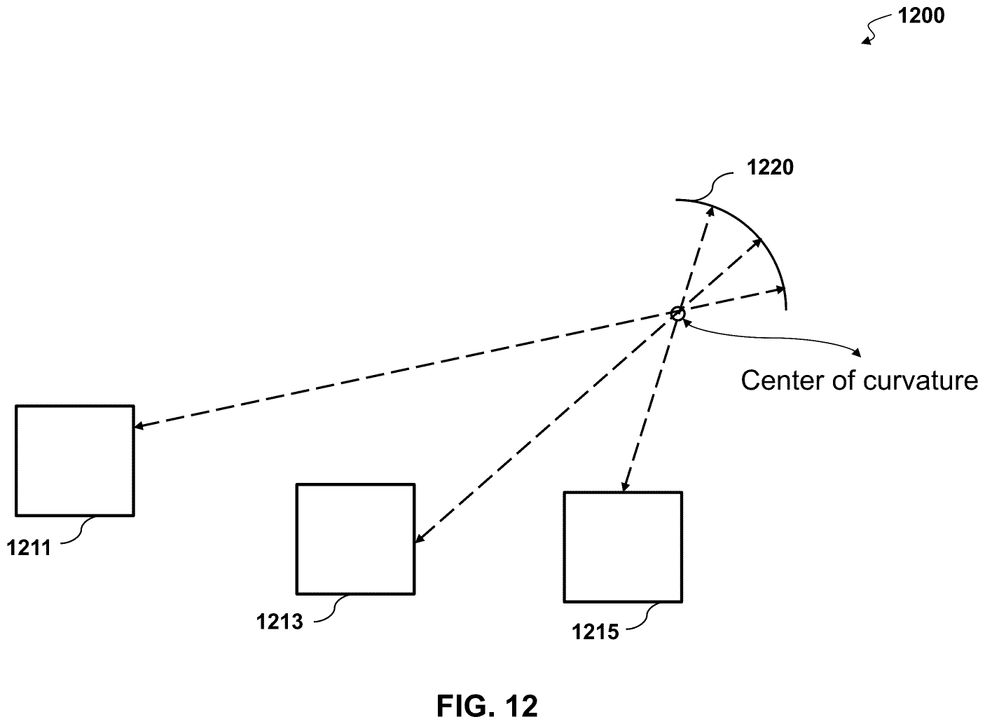

FIGS. 12 to 15 depict various systems each with at least one set of multiple laser sensors and a single retroreflector, according to various embodiments of the present disclosure. In each embodiment, the multiple laser sensors may be positioned in different locations in a monitored area and may be mounted on mobile platforms. The single retroreflector that the multiple laser sensors may aim to may be fixed.

FIG. 12 depicts a system 1200 having a tracking system with a curved retroreflector for two or more laser sensors. The system 1200 may comprise a curved retroreflector 1220 and a plurality of laser sensors 1211, 1213, 1215 each including a laser source and a detector. The laser sources of laser sensors 1211, 1213, 1215 of the tracking system may aim at the center of curvature of the curved retroreflector 1220 to ensure a reflection along the laser path and back to the detectors of the laser sensors 1211, 1213, 1215 of the tracking system. In some embodiments, the aim of the laser source of any one laser sensor 1211, 1213, 1215 may be diverted a distance from the center of curvature to redirect the laser beam to another desired location where a detector is located. The curved retroflector 1220 may be gimbal controlled or fixed in position. In some embodiments, a fixed position curved retroreflector 1220 may minimize or reduce a number of movable parts onboard the drone. The curved retroreflector 1220 over a planar retroreflector may have more than one solution for the return beam path.

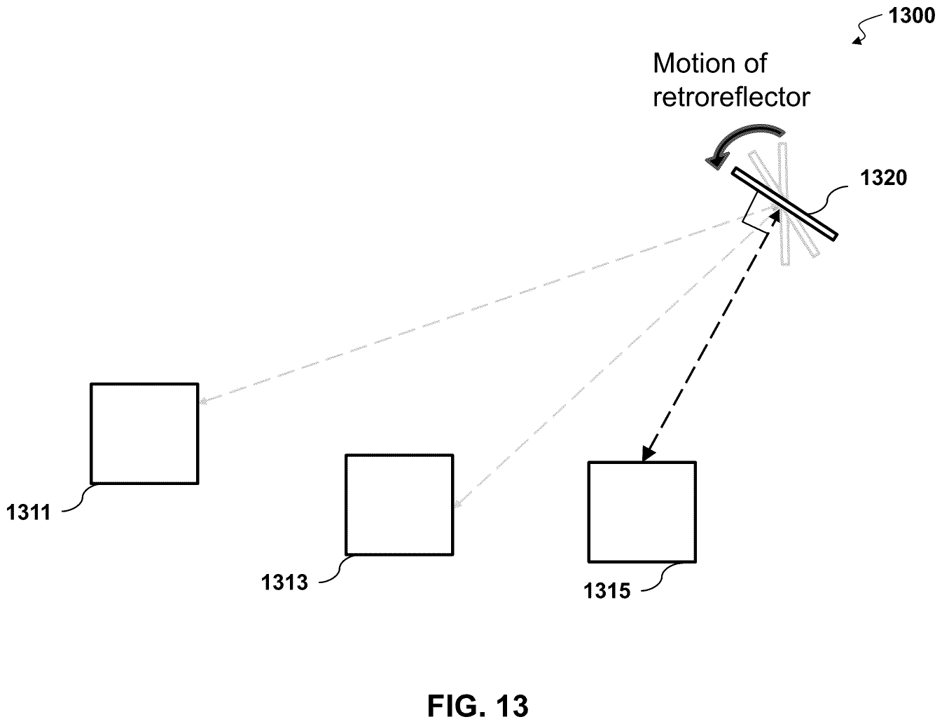

FIG. 13 depicts a system 1300 having another tracking system with a moveable planar retroreflector for two or more laser sensors. The system 1300 may comprise a moveable planar retroreflector 1320 and a plurality of laser sensors 1311, 1313, 1315 each including a laser source or a detector. The laser sources of the laser sensors 1311, 1313, 1315 of the tracking system may aim at the center of moveable planar retroreflector 1320, maintaining orthogonality between the laser beam and the surface of the moveable planar retroreflector 1320 to ensure a reflection along the laser path and back to the detectors of the laser sensors 1311, 1313, 1315 of the tracking system. The moveable planar retroreflector 1320 may be rotated along two axes to ensure a reflection back to the detectors of the laser sensors 1311, 1313, 1315 or may be manipulated to reflect to another desired location where a detector is located.

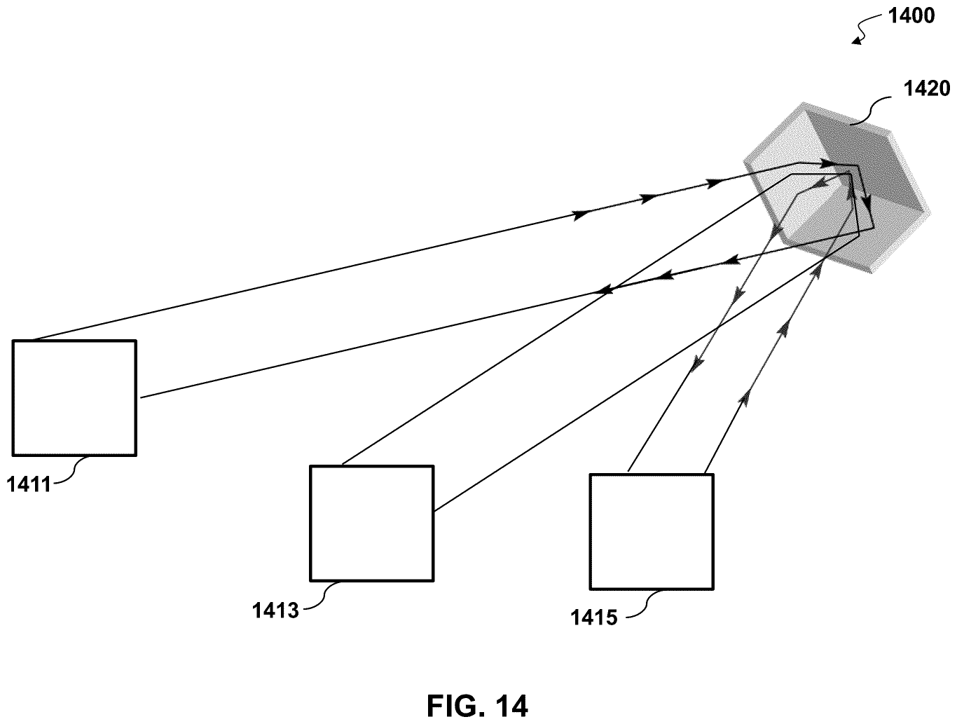

FIG. 14 depicts a system 1400 having another tracking system with a corner retroreflector for two or more laser sensors. The system 1400 may comprise a corner retroreflector 1420 and a plurality of laser sensors 1411, 1413, 1415 each including laser source or a detection device. The laser sources of the of laser sensors 1411, 1413, 1415 of the tracking system may aim at anywhere inside the corner retroreflector optic to ensure a reflection parallel to the laser path and back to the detectors of the laser sensors 1411, 1413, 1415 of the tracking system. The corner retroflector 1420 may be gimbal controlled or fixed in position. The advantage to a fixed position retroreflector is the minimization of movable parts onboard the drone. The corner retroreflector 1420 may be preferred over a planar retroreflector as it has more than one solution for the return beam path.

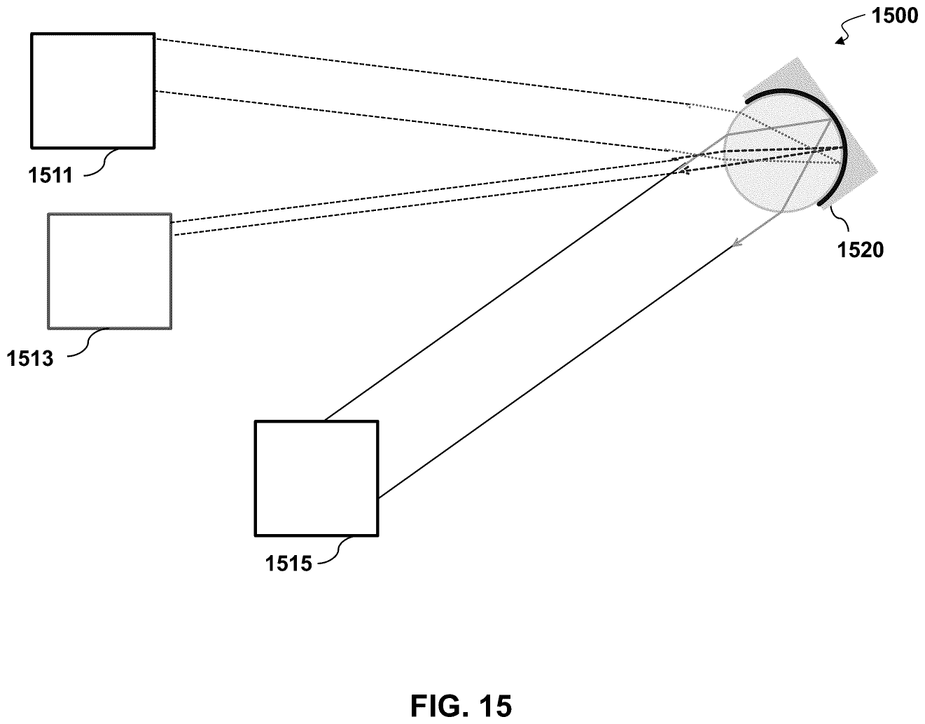

FIG. 15 depicts a system 1500 having another tracking system with a spherical retroreflector for two or more laser sensors. The system 1500 may comprise a spherical retroreflector 1520 and a plurality of laser sensors 1511, 1513, 1515 each including a laser source or a detector. The laser sources of the laser sensors 1511, 1513, 1515 of the tracking system may aim at anywhere on the spherical optic surface to ensure a reflection parallel to the laser path and back to the detectors of the laser sensors 1511, 1513, 1515 of the tracking system. The spherical retroflector 1520 may be gimbal controlled or fixed in position. The advantage to a fixed position retroreflector is the minimization of movable parts onboard the drone. The spherical retroreflector 1520 may be preferred over a planar retroreflector as it has more than one solution for the return beam path.

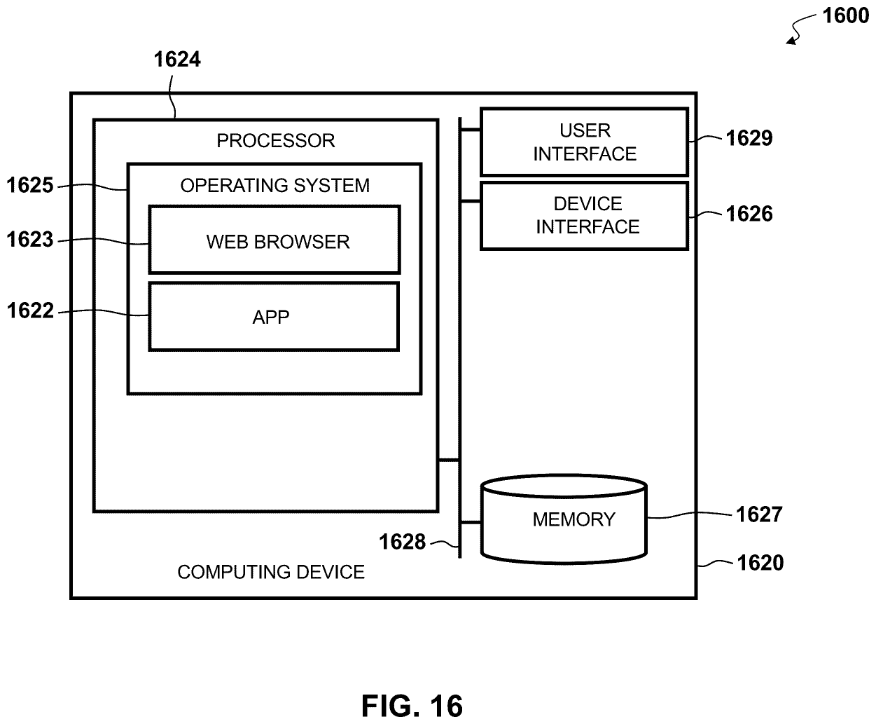

FIG. 16 illustrates an example of a top-level functional block diagram of a computing device embodiment 1600. The example operating environment is shown as a computing device 1620 comprising a processor 1624, such as a central processing unit (CPU), addressable memory 1627, an external device interface 1626, e.g., an optional universal serial bus port and related processing, and/or an Ethernet port and related processing, and an optional user interface 1629, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 1628. In some embodiments, via an operating system 1625 such as one supporting a web browser 1623 and applications 1622, the processor 1624 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

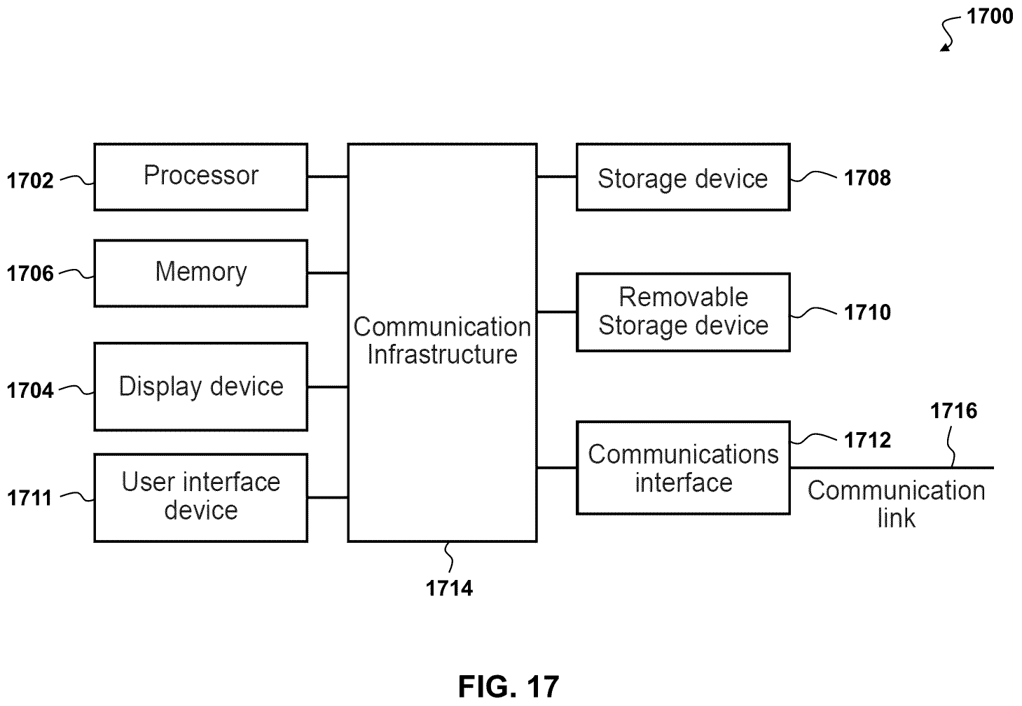

FIG. 17 is a high-level block diagram 1700 showing a computing system comprising a computer system useful for implementing an embodiment of the system and process, disclosed herein. Embodiments of the system may be implemented in different computing environments. The computer system includes one or more processors 1702, and can further include an electronic display device 1704 (e.g., for displaying graphics, text, and other data), a main memory 1706 (e.g., random access memory (RAM)), storage device 1708, a removable storage device 1710 (e.g., removable storage drive, a removable memory module, a magnetic tape drive, an optical disk drive, a computer readable medium having stored therein computer software and/or data), user interface device 1711 (e.g., keyboard, touch screen, keypad, pointing device), and a communication interface 1712 (e.g., modem, a network interface (such as an Ethernet card), a communications port, or a PCMCIA slot and card). The communication interface 1712 allows software and data to be transferred between the computer system and external devices. The system further includes a communications infrastructure 1714 (e.g., a communications bus, cross-over bar, or network) to which the aforementioned devices/modules are connected as shown.

Information transferred via communications interface 1714 may be in the form of signals such as electronic, electromagnetic, optical, or other signals capable of being received by communications interface 1714, via a communication link 1716 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1712. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

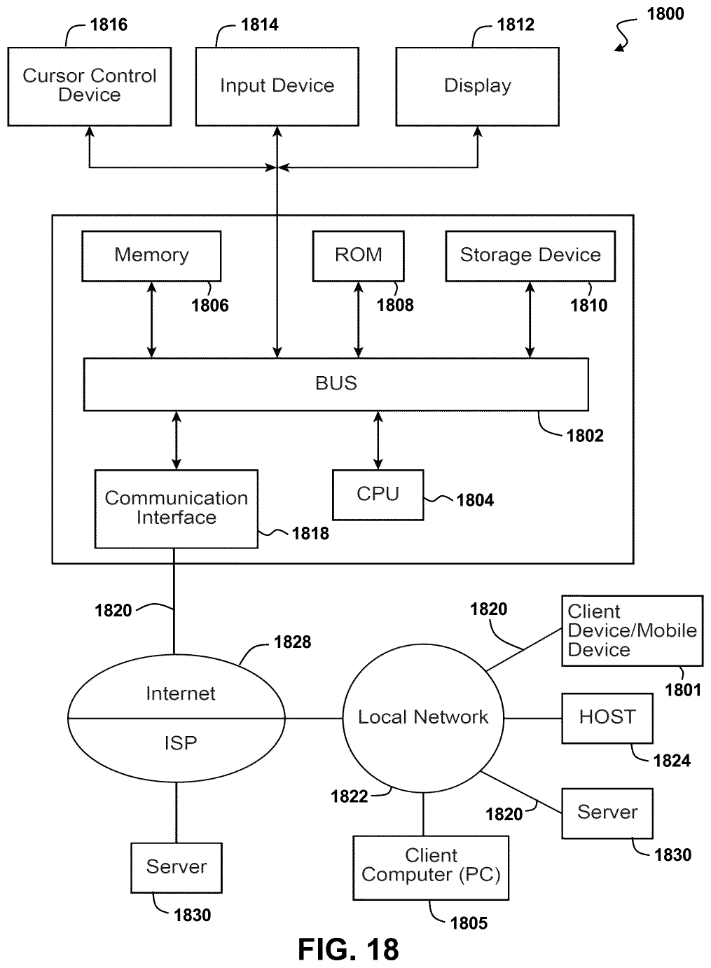

FIG. 18 shows a block diagram of an example system 1800 in which an embodiment may be implemented. The system 1800 includes one or more client devices 1801 such as consumer electronics devices, connected to one or more server computing systems 1830. A server 1830 includes a bus 1802 or other communication mechanism for communicating information, and a processor (CPU) 1804 coupled with the bus 1802 for processing information. The server 1830 also includes a main memory 1806, such as a random access memory (RAM) or other dynamic storage device, coupled to the bus 1802 for storing information and instructions to be executed by the processor 1804. The main memory 1806 also may be used for storing temporary variables or other intermediate information during execution or instructions to be executed by the processor 1804. The server computer system 1830 further includes a read only memory (ROM) 1808 or other static storage device coupled to the bus 1802 for storing static information and instructions for the processor 1804. A storage device 1810, such as a magnetic disk or optical disk, is provided and coupled to the bus 1802 for storing information and instructions. The bus 1802 may contain, for example, thirty-two address lines for addressing video memory or main memory 1806. The bus 1802 can also include, for example, a 32-bit data bus for transferring data between and among the components, such as the CPU 1804, the main memory 1806, video memory and the storage 1810. Alternatively, multiplex data/address lines may be used instead of separate data and address lines.

The server 1830 may be coupled via the bus 1802 to a display 1812 for displaying information to a computer user. An input device 1814, including alphanumeric and other keys, is coupled to the bus 1802 for communicating information and command selections to the processor 1804. Another type or user input device comprises cursor control 1816, such as a mouse, a trackball, or cursor direction keys for communicating direction information and command selections to the processor 1804 and for controlling cursor movement on the display 1812.

According to one embodiment, the functions are performed by the processor 1804 executing one or more sequences of one or more instructions contained in the main memory 1806. Such instructions may be read into the main memory 1806 from another computer-readable medium, such as the storage device 1810. Execution of the sequences of instructions contained in the main memory 1806 causes the processor 1804 to perform the process steps described herein. One or more processors in a multi-processing arrangement may also be employed to execute the sequences of instructions contained in the main memory 1806. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1804 for execution. Such a medium may take many forms, including but not limited to, non-volatile media, volatile media, and transmission media. Non-volatile media includes, for example, optical or magnetic disks, such as the storage device 1810. Volatile media includes dynamic memory, such as the main memory 1806. Transmission media includes coaxial cables, copper wire and fiber optics, including the wires that comprise the bus 1802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1804 for execution. For example, the instructions may initially be carried on a magnetic disk of a remote computer. The remote computer can load the instructions into its dynamic memory and send the instructions over a telephone line using a modem. A modem local to the server 1830 can receive the data on the telephone line and use an infrared transmitter to convert the data to an infrared signal. An infrared detector coupled to the bus 1802 can receive the data carried in the infrared signal and place the data on the bus 1802. The bus 1802 carries the data to the main memory 1806, from which the processor 1804 retrieves and executes the instructions. The instructions received from the main memory 1806 may optionally be stored on the storage device 1810 either before or after execution by the processor 1804.

The server 1830 also includes a communication interface 1818 coupled to the bus 1802. The communication interface 1818 provides a two-way data communication coupling to a network link 1820 that is connected to the world wide packet data communication network now commonly referred to as the Internet 1828. The Internet 1828 uses electrical, electromagnetic or optical signals that carry digital data streams. The signals through the various networks and the signals on the network link 1820 and through the communication interface 1818, which carry the digital data to and from the server 1830, are exemplary forms or carrier waves transporting the information.

In another embodiment of the server 1830, interface 1818 is connected to a network 1822 via a communication link 1820. For example, the communication interface 1818 may be an integrated services digital network (ISDN) card or a modem to provide a data communication connection to a corresponding type of telephone line, which can comprise part of the network link 1820. As another example, the communication interface 1818 may be a local area network (LAN) card to provide a data communication connection to a compatible LAN. Wireless links may also be implemented. In any such implementation, the communication interface 1818 sends and receives electrical electromagnetic or optical signals that carry digital data streams representing various types of information.

The network link 1820 typically provides data communication through one or more networks to other data devices. For example, the network link 1820 may provide a connection through the local network 1822 to a host computer 1824 or to data equipment operated by an Internet Service Provider (ISP). The ISP in turn provides data communication services through the Internet 1828. The local network 1822 and the Internet 1828 both use electrical, electromagnetic or optical signals that carry digital data streams. The signals through the various networks and the signals on the network link 1820 and through the communication interface 1818, which carry the digital data to and from the server 1830, are exemplary forms or carrier waves transporting the information.

The server 1830 can send/receive messages and data, including e-mail, program code, through the network, the network link 1820 and the communication interface 1818. Further, the communication interface 1818 can comprise a USB/Tuner and the network link 1820 may be an antenna or cable for connecting the server 1830 to a cable provider, satellite provider or other terrestrial transmission system for receiving messages, data and program code from another source.

The example versions of the embodiments described herein may be implemented as logical operations in a distributed processing system such as the system 1800 including the servers 1830. The logical operations of the embodiments may be implemented as a sequence of steps executing in the server 1830, and as interconnected machine modules within the system 1800. The implementation is a matter of choice and can depend on performance of the system 1800 implementing the embodiments. As such, the logical operations constituting said example versions of the embodiments are referred to for e.g., as operations, steps or modules.

Similar to a server 1830 described above, a client device 1801 can include a processor, memory, storage device, display, input device and communication interface (e.g., e-mail interface) for connecting the client device to the Internet 1828, the ISP, or LAN 1822, for communication with the servers 1830.

The system 1800 can further include computers (e.g., personal computers, computing nodes) 1805 operating in the same manner as client devices 1801, where a user can utilize one or more computers 1805 to manage data in the server 1830.

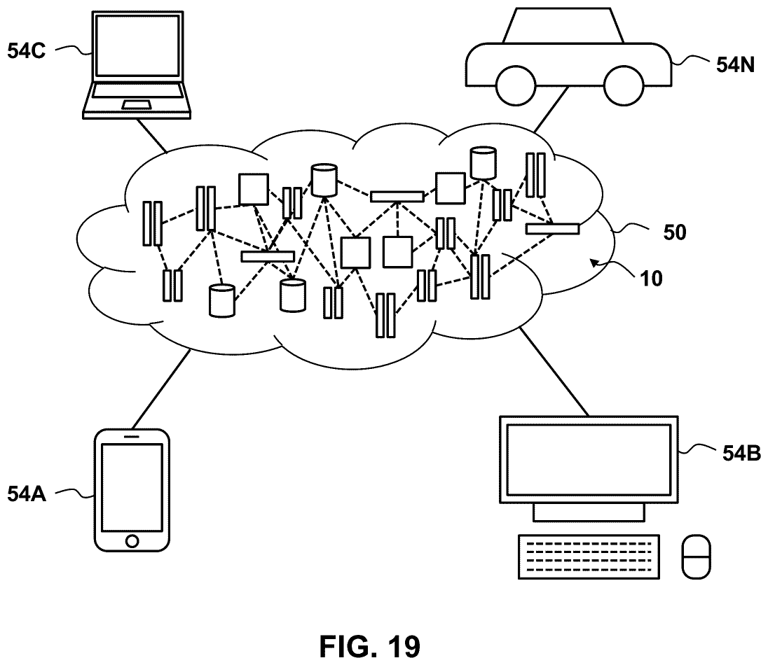

Referring now to FIG. 19, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or UAV system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 19 are intended to be illustrative only and that computing nodes 10 and cloud computing environment 50 can communicate with any type of computerized device over any type of network and/or network addressable connection (e.g., using a web browser).

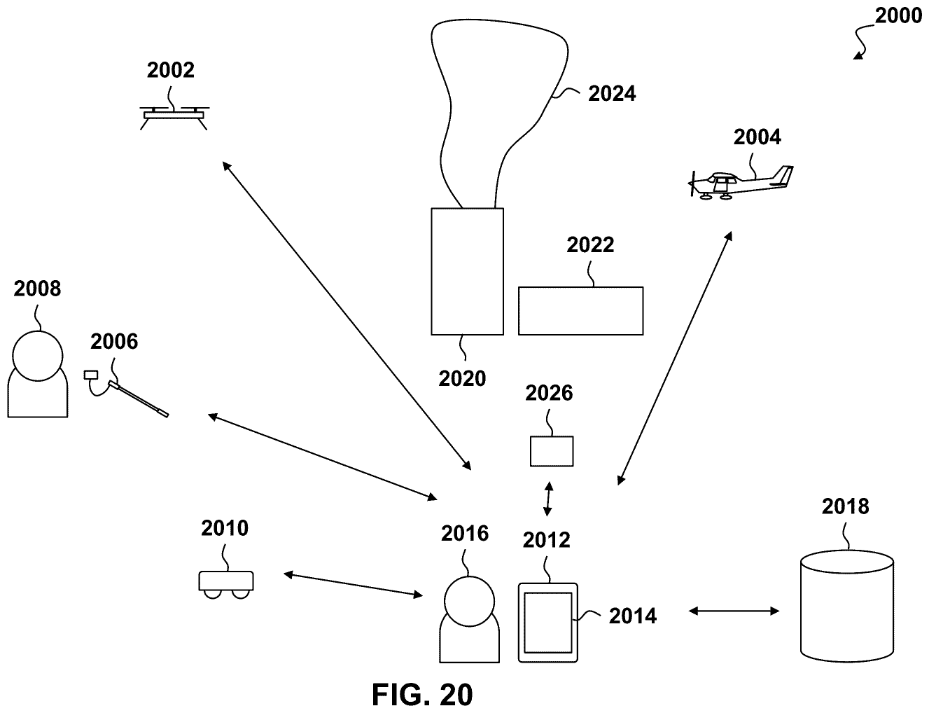

FIG. 20 depicts a system 2000 for detecting trace gases, according to one embodiment. The system may include one or more trace gas sensors located in one or more vehicles 2002, 2004, 2006, 2010. The one or more trace gas sensors may detect elevated trace gas concentrations from one or more potential gas sources 2020, 2022, such as a holding tank, pipeline, or the like. The potential gas sources 2020, 2022 may be part of a large facility, a small facility, or any location. The potential gas sources 2020, 2022 may be clustered and/or disposed distal from one another. The one or more trace gas sensors may be used to detect and quantify leaks of toxic gases, e.g., hydrogen disulfide, or environmentally damaging gases, e.g., methane, sulfur dioxide) in a variety of industrial and environmental contexts. Detection and quantification of these leaks are of interest to a variety of industrial operations, such as oil and gas, chemical production, and painting. Detection and quantification of leaks is also of value to environmental regulators for assessing compliance and for mitigating environmental and safety risks. In some embodiments, the at least one trace gas sensor may be configured to detect methane. In other embodiments, the at least one trace gas sensor may be configured to detect sulfur oxide, such as SO, SO2, SO3, S7O2, S6O2, S2O2, and the like. A trace gas leak 2024 may be present in a potential gas source 2020. The one or more trace gas sensors may be used to identify the trace gas leak 2024 and/or the source 2020 of the trace gas leak 2024 so that corrective action may be taken.

The one or more vehicles 2002, 2004, 2006, 2010 may include an unmanned aerial vehicle (UAV) 2002, an aerial vehicle 2004, a handheld device 2006, and a ground vehicle 2010. In some embodiments, the UAV 2002 may be a quadcopter or other device capable of hovering, making sharp turns, and the like. In other embodiments, the UAV 2002 may be a winged aerial vehicle capable of extended flight time between missions. The UAV 2002 may be autonomous or semi-autonomous in some embodiments. In other embodiments, the UAV 2002 may be manually controlled by a user. The aerial vehicle 2004 may be a manned vehicle in some embodiments. The handheld device 2006 may be any device having one or more trace gas sensors operated by a user 2008. In one embodiment, the handheld device 2006 may have an extension for keeping the one or more trace gas sensors at a distance from the user 2008. The ground vehicle 2010 may have wheels, tracks, and/or treads in one embodiment. In other embodiments, the ground vehicle 2010 may be a legged robot. In some embodiments, the ground vehicle 2010 may be used as a base station for one or more UAVs 2002. In some embodiments, one or more aerial devices, such as the UAV 2002, a balloon, or the like, may be tethered to the ground vehicle 2010. In some embodiments, one or more trace gas sensors may be located in one or more stationary monitoring devices 2026. The one or more stationary monitoring devices may be located proximate one or more potential gas sources 2020, 2022. In some embodiments, the one or more stationary monitoring devices may be relocated.

The one or more vehicles 2002, 2004, 2006, 2010 and/or stationary monitoring devices 2026 may transmit data including trace gas data to a ground control station (GCS) 2012. The GCS may include a display 2014 for displaying the trace gas concentrations to a GCS user 2016. The GCS user 2016 may be able to take corrective action if a gas leak 2024 is detected, such as by ordering a repair of the source 2020 of the trace gas leak. The GCS user 2016 may be able to control movement of the one or more vehicles 2002, 2004, 2006, 2010 in order to confirm a presence of a trace gas leak in some embodiments.

In some embodiments, the GCS 2012 may transmit data to a cloud server 2018. In some embodiments, the cloud server 2018 may perform additional processing on the data. In some embodiments, the cloud server 2018 may provide third party data to the GCS 2012, such as wind speed, temperature, pressure, weather data, or the like.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a mobile platform comprising:
an in situ trace gas sensor; and
a device configured to receive an open path laser beam.

2. The system of claim 1, wherein the mobile platform is a drone.

3. The system of claim 1, wherein the mobile platform further comprises an anemometer configured to generate wind measurements.

4. The system of claim 1, wherein the device configured to receive the open path laser beam is a retroreflector configured to receive and return the open path laser beam.

5. The system of claim 4, further comprising a fixed laser sensor, wherein the fixed laser sensor is configured to emit the open path laser beam and receive the returned open path laser beam from the retroreflector on the mobile platform.

6. The system of claim 4, further comprising a mobile laser sensor, wherein the mobile laser sensor is configured to emit the open path laser beam and receive the returned open path laser beam from the retroreflector on the mobile platform.

7. The system of claim 1, wherein the device configured to receive the open path laser beam is a detection device, wherein the detection device comprises processing electronics configured to interpret at least one of: a laser dispersion and an absorption signal.

8. The system of claim 1, wherein the in situ trace gas sensor is an open cavity Tunable Diode Laser Absorption Spectrometer (TDLAS), wherein the open cavity TDLAS is configured to refine positional and quantification uncertainty.

9. The system of claim 1, further comprising:
a processor having addressable memory, wherein the processor is in communication with the in situ trace gas sensor, wherein the device is configured to receive the open path laser beam from at least one of: a fixed laser sensor and a mobile laser sensor, and wherein the processor is configured to:
confirm that a gas detected by at least one of: the in situ trace gas sensor, the device configured to receive the open path laser beam, and the at least one of: the fixed laser sensor and the mobile laser sensor is a trace gas that is present in a vicinity of the mobile platform rather than somewhere along a path of the open path laser beam.

10. The system of claim 9, wherein the processor is further configured to:
determine a position of a localized source emitting the detected gas.

11. The system of claim 10, wherein the mobile platform is deployed in response to the gas detected by the at least one of: the fixed laser sensor and the mobile laser sensor to refine the determined position of the localized source and yield a real-time quantification estimate.

12. A system comprising:
at least one laser sensor, wherein each laser sensor is configured to emit an open path laser beam; and
at least one mobile platform, wherein each mobile platform comprises a first retroreflector configured to reflect the open path laser beam transmitted from the at least one laser sensor;
wherein the at least one laser sensor is configured to detect, locate, and quantify trace gas based on the open path laser beam reflected from the first retroreflector.

13. The system of claim 12, further comprising:
at least one second retroreflector fixed in a monitored area and configured to monitor the monitored area continuously; and
a processor having addressable memory, wherein the processor is in communication with the at least one laser sensor and the at least one mobile platform, wherein the processor is configured to:
generate an alarm when the at least one laser sensor detects trace gas based on the open path laser beam reflected from the at least one second retroreflector; and
transmit the alarm to the at least one mobile platform;
wherein the operations of the at least one mobile platform is triggered by the alarm.

14. The system of claim 13, wherein the at least one mobile platform further includes an in situ trace gas sensor, wherein the operation of the in situ trace gas sensor is triggered by the alarm, wherein the in situ trace gas sensor is configured to:
receive the open path laser beam from the at least one laser sensor;
independently detect, locate, and quantify trace gas; and
refine positional and quantification uncertainty obtained by the at least one laser sensor.

15. The system of claim 12, wherein the at least one mobile platform comprises a plurality of mobile platforms, and a plurality of first retroreflectors of the plurality of mobile platforms are configured to reflect the open path laser beam transmitted from one of the at least one laser sensor.

16. The system of claim 12, wherein the at least one mobile platform further comprises an in situ trace gas sensor configured to:
receive the open path laser beam from the at least one laser sensor;
independently detect, locate, and quantify trace gas; and
refine positional and quantification uncertainty obtained by the at least one laser sensor.

17. The system of claim 12, wherein any one of the at least one laser sensor is located at one of: a fixed position and a mobile platform.

18. The system of claim 12, wherein the at least one laser sensor includes a plurality of laser sensors, and the plurality of laser sensors are configured to aim to one of the first retroreflector of the at least one mobile platform, wherein the plurality of laser sensors are mounted on mobile platforms, and the first retroreflector to which the plurality of laser sensors aim is fixed.

19. The system of claim 18, wherein the first retroreflector is at least one of:
a curved retroreflector;
a moveable planar retroreflector;
a corner retroreflector; and
a spherical retroreflector.

20. The system of claim 12, wherein the mobile platform further comprises a detection device, wherein the detection device comprises processing electronics configured to interpret at least one of: a laser dispersion and an absorption signal.
